(19) United States
(12) Patent Application Publication
(10) Pub. No.: US 2024/0149338 A1
(43) Pub. Date: May 9, 2024

(54) METAL POWDER INJECTION MOLDING PRODUCT FOR METALLIC FRAME, THE SYSTEM COMPRISING THE METAL POWDER INJECTION MOLDING PRODUCT AND THE MANUFACTURING METHOD USING THE SYSTEM

(71) Applicant: PIM KOREA CO., LTD, Daegu (KR)

(72) Inventor: Jun Ho SONG, Daegu (KR)

(73) Assignee: PIM KOREA CO., LTD, Daegu (KR)

(21) Appl. No.: 18/521,392

(22) Filed: Nov. 28, 2023

Related U.S. Application Data
(63) Continuation of application No. PCT/KR2022/007892, filed on Jun. 3, 2022.

(30) Foreign Application Priority Data
Jun. 10, 2021 (KR) 10-2021-0075321
Jun. 10, 2021 (KR) 10-2021-0075322
Apr. 25, 2022 (KR) 10-2022-0050559
Apr. 25, 2022 (KR) 10-2022-0050565
Apr. 25, 2022 (KR) 10-2022-0050569

(51) Int. Cl. B22F 3/10; B22F 1/10; B22F 3/22

(52) U.S. Cl. CPC B22F 3/10; B22F 1/10; B22F 3/225; B22F 2003/1046

(57) ABSTRACT

The present invention relates to a method for manufacturing a basic metallic frame product used to produce a metallic frame as a part of an electronic product such as a smartphone, a smart key, a remote controller, and the like, and to a metal injection molded system including a metal injection molded product made with a mixture of metal powder and a binder and a support means for fixing the metal injection molded product to prevent the molded side wall from shrinking in the longitudinal direction thereof during a sintering process of the metal injection molded product. As the basic metallic frame product made using the system is provided, the metallic frame may be easily mass-produced, the production cost of the metallic frame may be lowered, and an amount of metal consumed for making the metallic frame may be reduced.

### CROSS-REFERENCE TO RELATED APPLICATION(S)

This application is a bypass continuation application of International Application No. PCT/KR2022/007892, filed on Jun. 3, 2022, which claims priority from Korean Patent Application No. 10-2021-0075321, filed on Jun. 10, 2021; Korean Patent Application No. 10-2021-0075322, filed on Jun. 10, 2021; Korean Patent Application No. 10-2022-0050559, filed on Apr. 25, 2022; Korean Patent Application No. 10-2022-0050565, filed on Apr. 25, 2022; and Korean Patent Application No. 10-2022-0050569, filed on Apr. 25, 2022, in the Korean Intellectual Property Office, the disclosures of which are incorporated herein by reference in their entireties.

### TECHNICAL FIELD

The present invention relates to a method for manufacturing a metallic edge (frame) used as a part of an electronic product such as a smartphone, a smart key, a remote controller, and the like, more specifically to a metal injection molded product newly provided to make a metallic frame by sintering metal powder, a system having the metal injection molded product, and a method for manufacturing a basic metallic frame product using the system.

That is, the present invention relates to a metal injection molded product, a system comprising the metal injection molded product, and a method for manufacturing a basic metallic frame product using the system that are capable of producing a metallic frame using a sintered metal not applied in manufacturing the metallic frame in conventional practices, more specifically to a system comprising a metal injection molded product having a new shape and function applied in producing a metallic frame using a sintered metal and a support means for supporting the metal injection molded product and a method for manufacturing a basic metallic frame product using the system.

### BACKGROUND ART

A metallic frame is widely used to improve the strength and aesthetics of electronic products such as a smartphone, a smart key, a remote controller, and the like.

A conventional metallic frame is made through a lot of processes (in the past, 30 processes needed in Pantech) such as a metal lump cutting process, a cut metal machining process, and the like.

According to the conventional method for making the metallic frame, an amount of waste metal during the cutting and machining processes is larger than an amount of metal used for a finished product, and therefore, a raw material loss undesirably increases. Further, most of the production cost is occupied by the machining cost, not by the metal price of the metallic frame itself.

In spite of many advantages the metallic frame has, therefore, companies producing finished products, such as Samsung Electronics Co., Ltd., etc. do not adopt such metallic frames for a long time because of high production costs and supply and demand problems of the metallic frames.

Metal Injection Molding (MIM) is a process in which general plastic injection molding is combined with metal powder sintering developed in a powder metallurgy field.

The metal injection molding is possible to make three-dimensional precision parts with all powder materials such as metals, ceramic, hard metals, intermetallic compounds, and the like and capable of molding precise and complex parts such as materials with difficult machinability or materials impossible in casting up to a step in which post-machining is barely required, so that the metal injection molding advantageously ensures mass production.

If it is desired to inject high gravity metal powder into a mold, a binder in which resin and wax are mixed is mixed with the metal powder to improve metal powder binding and fluidity during the injection, and in this case, a quality of an injection molded product may be varied according to the properties of the binder. Further, a debinding process of removing the binder is required, which affects the quality and productivity of a sintered product made out of the injection molded product.

Besides, the injection molded product may shrink when sintered, and accordingly, in the case of a part such as a metallic frame that has a relatively lower thickness and a relatively smaller width when compared with its entire size, tries to make the metallic frame, using the metal injection molding through which the part may be easily deformed and broken by a sintering process, have been not found yet.

### SUMMARY

The present invention relates to a method for manufacturing a metallic frame inserted into a casing of an electronic product such as a smartphone, a smart key, and the like, while solving the problems the conventional technologies have had.

Accordingly, it is an object of the present invention to provide a method for manufacturing a basic metallic frame product that does not need to require a process of making a metallic frame through a metal lump cutting process and a cut metal machining process because the process is extremely labor-intensive and makes individual products one by one, thereby making it hard to achieve mass production.

It is another object of the present invention to provide a method for manufacturing a basic metallic frame product that is capable of solving the problems the conventional metallic frame making method, in which numerous individual processes are needed to cause a lot of time and a high manufacturing cost, has had.

It is yet another object of the present invention to provide a method for manufacturing a basic metallic frame product that is capable of solving the problems the conventional metallic frame making method, in which an amount of metal waste after a cutting process is larger than an amount of metal produced as a metallic frame, had had.

The present invention relates to a method for manufacturing a metallic frame for an electronic part using a sintered metal not applied in conventional practices, more specifically to a method for manufacturing a basic metallic frame product that includes the steps of making a metal injection molded product using metal injection molding, sintering the metal injection molded product, and producing the basic metallic frame product, a metal injection molded product having a new shape and function used in the method, and a system comprising the metal injection molded product.

As shown in FIGS. 1a to 1d, a basic metallic frame product requires relatively thinner and longer molded side walls when compared with the entire size thereof, and it is not easy to make a metal injection molded product having such thinner and longer molded side walls through a sintering process.

This is because the molded side walls may shrink when the metal injection molded product is sintered, thereby causing deformation such as twisting and breakage such as cutting on the molded side walls.

According to one aspect of the present invention, there is provided a metal injection molded product including a molded side wall to be provided as a basic metallic frame product after a sintering process and fixing means extending from one or both ends of the molded side wall in a longitudinal direction of the molded side wall.

According to the present invention, the metal injection molded product may be provided with the fixing means disposed on one or both ends of the molded side wall to prevent the molded side wall from being deformed and broken during the sintering process, and in a state where the fixing means is fixedly supported against a separate support means, the molded side wall may be subjected to the sintering process to prevent the molded side wall from being deformed and broken during the sintering process.

The fixing means may serve to fix the molded side wall to prevent the molded side wall from shrinking in the longitudinal direction of the side wall during the sintering process, and after the sintering process, the fixing means may cut in such a way as to be removable from the molded side wall.

The molded side wall may include one or more side walls, and the molded side wall may be configured to have two or more side walls intersecting. The intersecting side walls may have acute, obtuse, or right angles with respect to one another.

According to the present invention, the fixing means may include any one selected among a fixing base extending from the end of the molded side wall in the longitudinal direction of the molded side wall and having a fixing portion formed therein, a transverse fixing rod extending from the end of the molded side wall in any or more directions of left and right directions of the molded side wall, and an end corner having a bent portion formed on one side of the end of the molded side wall, or a combination thereof. The fixing means may include other various shapes.

According to the present invention, the metal injection molded product may be fixedly supported against the separate support means, subjected to the sintering process, and provided as the basic metallic frame product.

According to another aspect of the present invention, there is provided a metal injection molded product including the above-mentioned metal injection molded product and the support means for fixedly supporting the metal injection molded product so that the metal injection molded product fixed to the support means is subjected to the sintering process. The support means may be coupled to the fixing means of the metal injection molded product to prevent the molded side wall from shrinking in the longitudinal direction thereof during the sintering process.

The support means may include any one of one or more fixing pins coupled to the fixing portion and one or more corner inside supports coming into contact with the inner corners formed by the transverse fixing rod or the inner corner of the end corner.

According to the present invention, the metal injection molded product may have the shape open in one direction or the shape closed, and the shape may be any one among a straight shape having one side wall, a shape of [symbol] having two side walls, a shape of [symbol] having three side walls, and a square shape having four side walls. However, the present invention may not be limited thereto.

According to the present invention, the metal injection molded product may further include a cutting line between the molded side wall and the fixing means, and after the sintering process of the metal injection molded product, the fixing means may be removed along the cutting line from the molded side wall, thereby providing the shape of the basic metallic frame product.

According to the present invention, the metal injection molded product may be configured to have the fixing means formed on a portion where the molded side walls intersect unified as one to fix the corresponding molded side walls thereto.

According to the present invention, the metal injection molded product may include a mixture of metal powder and a binder.

To make the metallic frame out of the metal injection molded product, as mentioned above, the molded side wall may have to be prevented from being deformed and broken during the sintering process, and to do this, a mixture comprising metal powder and a binder constituting the metal injection molded product may have to be appropriately selected.

That is, a mixture of metal powder and a binder, which is easily molded to the shape of a basic metallic frame product as required and keeps the molded shape even during the sintering process, may be needed.

The metal powder included in the mixture of metal powder and a binder may include one selected from molybdenum, tungsten, and an alloy thereof; alloy steel with Fe as a main component; stainless alloy steel such as SUS630, SUS316, and SUS304; and titanium and titanium alloys, or a combination of two or more thereof.

According to the present invention, the mixture of the metal powder and the binder may include titanium hydride as the metal powder, and the mixture may comprise: 45 to 75% by volume of titanium hydride powder; and 55 to 25% by volume of the binder comprising 40 to 60% by weight of wax and 60 to 40% by weight of polymers. The binder may comprise 40 to 60% by weight of paraffin wax, 15 to 30% by weight of polypropylene, 10 to 30% by weight of polyethylene, and 1 to 10% by weight of amorphous polyalphaolefin, desirably 55 to 60% by weight of paraffin wax, 15 to 20% by weight of polypropylene, 15 to 20% by weight of polyethylene, and 1 to 5% by weight of amorphous polyalphaolefin.

According to the present invention, the mixture of the metal powder and the binder may include stainless alloy steel powder as the metal powder, and the mixture may comprise: 47.5 to 65% by volume of stainless alloy steel powder; and 52.5 to 35% by volume of the binder comprising 40 to 60% by weight of wax and 60 to 40% by weight of polymers, desirably 55 to 60% by volume of stainless alloy steel powder; and 45 to 40% by volume of the binder comprising 40 to 60% by weight of wax and 60 to 40% by weight of polymers. The binder may comprise 10 to 20% by weight of polypropylene, 25 to 35% by weight of polyacetal, 1 to 10% by weight of amorphous polyalphaolefin, 45 to 55% by weight of paraffin wax, and 1 to 10% by weight of carnauba wax, desirably 10 to 15% by weight of polypropylene, 25 to 30% by weight of polyacetal, 1 to 5% by weight of amorphous polyalphaolefin, 45 to 50% by weight of paraffin wax, and 1 to 5% by weight of carnauba wax.

According to the present invention, the support means of a metal injection molded system may include any one of one or more fixing pins coupled to the fixing portion of the fixing means and one or more corner inside supports coming into contact with the inner corners formed by the transverse fixing rod or the inner corner of the end corner, and the support means may prevent the molded side wall from shrinking in the longitudinal direction thereof during the sintering process of the metal injection molded product to keep the molded side wall from being deformed and broken during the sintering process.

Only if the fixing means and the support means for fixedly supporting the fixing means have shapes capable of preventing the molded side wall from shrinking in the longitudinal direction thereof, they may have free shapes.

According to the present invention, one or more fixing pins that are coupled to the fixing means and one or more corner inside supports that come into contact with the inner corners formed by the transverse fixing rod or the inner corner of the end corner may be fixed to the support means.

According to the present invention, the support means of the metal injection molded system may be configured to be easily separated from the metal injection molded product after the sintering process. That is, the support means may include an unreactive material such as a ceramic material or graphite powder, and the unreactive material may prevent the support means from reacting to the fixing means of the metal injection molded product so that after the sintering process, the basic metallic frame product is easily separated from the support means.

The treatment through which the fixing means and the support means do not react to the molded side wall may be performed by selecting one among (a) a method in which the support means is entirely made of an unreactive material that does not react to the molded side wall, (b) a method in which an unreactive material that does not react to the molded side wall is applied to the outer surface of the support means, and (c) a method in which an unreactive material or solution is applied to any one or more surfaces where the support means and the molded side wall are brought in contact with each other and then dried or sintered.

In more detail, the treatment through which the fixing portions and the fixing pins and the transverse fixing rods or the end corners and the corner inside supports do not react to one another may be performed, and the treatment may be performed by selecting one among a method in which the fixing pins and the corner inside supports are entirely made of an unreactive material that does not react to the molded side wall, a method in which stiff metals are inserted into the fixing pins and the corner inside supports and an unreactive material that does not react to the molded side wall is applied to the outer surfaces of the fixing pins and the corner inside supports, and a method in which an unreactive material or solution is applied to any one or more surfaces where the fixing pins and the corner inside supports are brought into contact with the fixing portions and the transverse fixing rods or the end corners and then dried or sintered. The unreactive material may comprise any one of ceramic powder and graphite powder or a combination of two or more thereof.

According to the present invention, the metal injection molded system may further include one or more inside fixing supports disposed along the inner surfaces of intermediate bending portions where the molded side walls intersect or along the inner surfaces of side wall intermediate corners where the fixing means intersect.

The inside fixing supports may additionally support the inner surfaces of the intermediate bending portions and the intermediate corners, together with the fixing pins or the corner inside supports, to prevent the molded side walls from shrinking in given directions during the sintering process so that the metallic frame may be made to various shapes.

According to the present invention, the metal injection molded system may have a restrained gap between the support means and the metal injection molded product in the range of 1.5 to 5.5%.

According to the present invention, the metal injection molded system may allow a plurality of metal injection molded products to be subjected to the sintering process at a time.

The metal injection molded system may include a support means for supporting a plurality of metal injection molded products at a time, and the support means may include means for fixing the fixing means of the plurality of metal injection molded products at a time so that the plurality of metal injection molded products are fixed thereto.

The means for fixing the fixing means of the plurality of metal injection molded products at a time may be any one or more selected from one or more multi-connection fixing pins or one or more multi-connection corner inside supports for fixing any one or more selected from the fixing bases extending from the ends of the molded side walls in the longitudinal directions of the molded side walls and having the fixing portions formed therein, the transverse fixing rods extending from the ends of the molded side walls in any or more directions of left and right directions of the molded side walls, and the end corners having bent portions formed on one side of the ends of the molded side walls, and the multi-connection fixing pins may be coupled to the plurality of fixing portions, whereas the multi-connection corner inside supports may come into contact with the inside corners formed by the transverse fixing rods or the inside corners formed by the end corners.

According to an embodiment of the present invention, the system capable of sintering the plurality of metal injection molded products at a time may be configured to allow the plurality of metal injection molded products fixed correspondingly to a plurality of support means to be stacked on top of one another and to allow the multi-connection fixing pins or multi-connection corner inside supports to be disposed to pass through the corresponding support means in such a way as to coupledly pass through the fixing portions, the transverse fixing rods, or the end corners of the plurality of metal injection molded products.

According to another embodiment of the present invention, the metal injection molded system may be configured to allow a plurality of metal injection molded products to be spaced apart in a stacked manner from one another by means of spacing members and to allow the multi-connection fixing pins or multi-connection corner inside supports fixed to the support means to coupledly pass through the fixing portions, the transverse fixing rods, or the end corners of the plurality of metal injection molded products.

According to yet another embodiment of the present invention, the metal injection molded system may be configured to allow two support means to stand up to face each other, while a plurality of metal injection molded products are spaced apart in a stacked manner from one another by means of spacing members between the two support means, and to allow the multi-connection fixing pins or multi-connection corner inside supports fixed to the support means to coupledly pass through the fixing portions, the transverse fixing rods, or the end corners of the plurality of metal injection molded products.

According to the present invention, the support means for supporting the plurality of metal injection molded products at a time may further include the spacing members disposed between the neighboring metal injection molded products.

According to the present invention, the support means for supporting the plurality of metal injection molded products at a time may further include one or more multi-connection inside fixing supports disposed along the inner surfaces of intermediate bending portions where the molded side walls intersect or along the inner surfaces of side wall intermediate corners where the fixing means intersect.

The multi-connection fixing pins, the multi-connection corner inside supports, and the multi-connection inside fixing supports may comprise an unreactive material that does not react to the fixing portions, the transverse fixing rods or end corners, and the intermediate bending portions or intermediate corners, and the method through which the unreactive material is included may be the same as in the case of the above-mentioned support means, fixing pins, and corner inside supports.

According to the present invention, the metal injection molded system may further include a guide member for supporting any one or more among the inner surface, the outer surface, the inner and outer surfaces, the width direction, and the thickness direction of the molded side wall. The guide member may keep the molded side wall in shape to prevent the molded side wall from sagging and may freely change the shape of the basic metallic frame product so that the basic metallic frame product may be made to various shapes. Further, the guide member may be added to a portion of the molded side wall if the molded side wall is long to be difficult to be supported only with the fixing means, thereby preventing the molded side wall from being deformed during the sintering process.

According to the present invention, the guide member may be treated to have no reaction to the molded side wall.

According to yet another aspect of the present invention, there is provided a method for manufacturing a basic metallic frame product, the method comprising the steps of: designing a shape of a product to be made by metal injection molding; making a mold based on the designed shape; mixing metal powder and a binder to make a mixture of the metal powder and the binder; and injecting the mixture into the mold made according to the shape of the product to be made by the metal injection molding to make a metal injection molded product.

The metal injection molded product may include a molded side wall for making a metallic frame having one or more sides and fixing means extending from one or both ends of the molded side wall in a longitudinal direction of the molded side wall to fix the molded side wall thereto, so that the molded side wall is prevented from shrinking in the longitudinal direction thereof during a sintering process, and then cutting after the sintering process in such a way as to be removable from the molded side wall.

The mixture of the metal powder and the binder may include 45 to 75% by volume of the metal powder and 55 to 25% by volume of the binder.

According to the present invention, the method for manufacturing a basic metallic frame product may further include the steps of: allowing the metal injection molded product to be subjected to debinding, fixed to a support means coupled to the fixing means to prevent the molded side wall of the metal injection molded product from shrinking during the sintering process, and subjected to the sintering process; separating the basic metallic frame product from the support means; and cutting the fixing means.

According to the present invention, a finished metallic frame product may be made out of the basic metallic frame product made through the above-mentioned steps by additional machining processes.

According to the present invention, a new method is provided to manufacture a metallic frame inserted into a casing of an electronic product such as a smartphone, a smart key, and the like, thereby allowing the metallic frame to be easily mass-produced and lowering a production cost of the metallic frame. Further, the method according to the present invention has a smaller amount of metal used than the conventional metallic frame manufacturing method, thereby providing resource saving effects.

### BRIEF DESCRIPTION OF DRAWINGS

FIGS. 1a to 1d show basic metallic frame products manufactured by a metal injection molded product for a metallic frame according to the present invention.

FIGS. 2a to 2d show examples of a metal injection molded system having a metal injection molded product for a metallic frame and a support means, wherein representative four types of systems and support means are shown, while having the metal injection molded product having one side fixing base and the opposite side fixing base, fixing pins disposed on the fixing bases in such a way as to be treated on the surfaces coming into contact with the fixing bases to have no reaction to the fixing bases, and the support means for fixedly supporting the fixing pins.

FIG. 2e shows an embodiment wherein the metal injection molded product has the shape of [symbol] with the two or more side walls and one fixing base is unitarily formed on the outside of the intersecting portion of the two side walls to prevent the two side walls from shrinking in the longitudinal directions thereof during a sintering process.

FIG. 2f is a perspective view showing the metal injection molded product having only one side wall.

FIGS. 3a to 3d show metal injection molded systems according to other embodiments of the present invention in which two or more metal injection molded products are stacked on top of one another and are sintered at a time.

FIGS. 4a to 4e show other examples of fixing means and the support means according to the present invention.

FIGS. 5a to 5e show examples in which if the metal injection molded product has two molded side walls having the shape of ‘ [symbol] ’ or the three molded side walls having the shape of ‘ [symbol] ’, one or more inside fixing supports are additionally disposed along the inner surfaces of intermediate bending portions where the side walls intersect or along the inner surfaces of side wall intermediate corners where the fixing means intersect.

FIGS. 6a to 6d show metal injection molded systems according to yet other embodiments of the present invention wherein in the case of the metal injection molded product having transverse fixing rods and the end corners as the fixing means, the two or more metal injection molded products are stacked on top of one another and sintered at a time.

FIG. 7 shows a metal injection molded system according to another embodiment of the present invention in which a guide member is further provided to make the thickness, width, etc. of the molded side wall formed differently in shape.

Hereinafter, explanations of reference numerals in the drawings will be given below.

100, 200, 300, 400, 700, 900, 1000, 1100, 1200, 1300, 1400: Side wall

110, 910, 1010, 1110, 1210, 1310, 1410: Fixing means

111, 911, 1011, 1111, 1211, 1311, 1411: Fixing base

112, 912, 1012, 1112, 1212, 1312, 1412: Fixing portion

113, 913, 1013, 1113, 1213, 1313, 1413: Fixing pin

114, 214, 314, 414, 614, 714, 814, 914, 1014, 1214, 1314, 1414: Support means

110: End corner

219, 220, 319, 320, 419, 420, 719, 720, 919: Transverse fixing rod

120: Multi-connection fixing pin

130, 700a, 745: Spacing member

140, 141, 142, 143, 240, 241, 243, 244, 340, 341, 344, 345, 440, 441, 444, 445, 740, 741, 743, 744, 940, 941, 1140, 1141, 1144, 1145, 1240, 1241, 1243, 1244, 1340, 1341, 1343, 1344, 1440, 1441, 1443, 1444: Corner inside support or multi-connection corner inside support

150: Guide member

170: Intermediate corner

180: Inside corner

201, 301, 302, 401, 402: Intermediate bending portion

242, 342, 343, 442, 443, 742, 1040, 1142, 1143, 1242, 1342, 1442, 1143, 1242, 1342, 1442: Inside fixing support and multi-connection inside fixing support

310: Cutting line

### DETAILED DESCRIPTION

Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

Terms used in this application are used to only describe specific exemplary embodiments and are not intended to restrict the present invention. An expression referencing a singular value additionally refers to a corresponding expression of the plural number, unless explicitly limited otherwise by the context. In the description, when it is said that one portion is described as “comprises” and/or “comprising” any component, one element further may include other components unless no specific description is suggested.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, embodiments of the present invention will be described in detail with reference to the attached drawings.

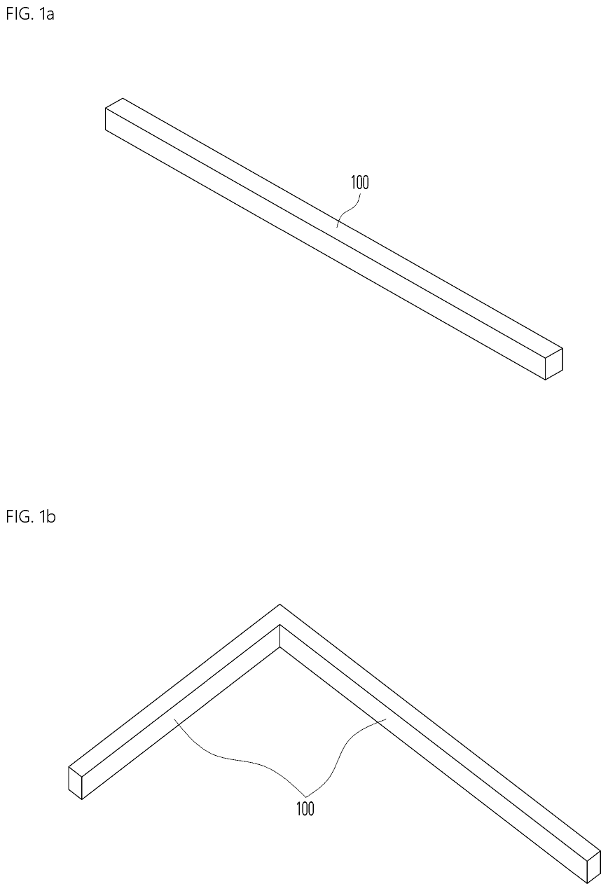

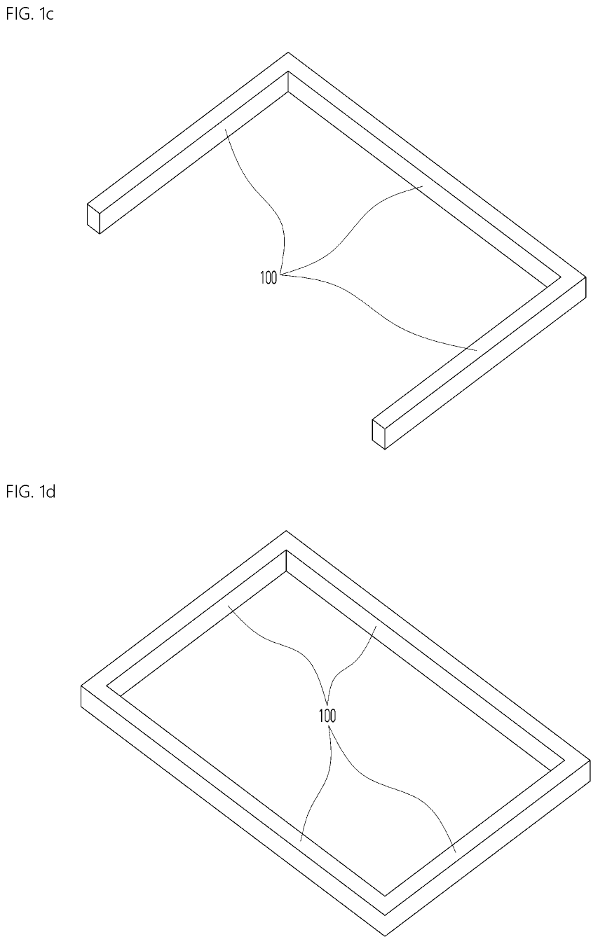

FIGS. 1a to 1d show examples of basic metallic frame products, to which the present invention is applied, before a straight type metallic frame having one side wall 100, a [symbol] -shaped metallic frame having two side walls 100 intersecting with each other, a [symbol] -shaped metallic frame having three side walls 100 intersecting with one another, and a square type metallic frame having four side walls 100 intersecting with one another are made, and in this case, the metallic frames are made with a concept wherein they are made out of metal injection molded products for a metallic frame and a concept wherein sintering time remarkably extends longer than that when a conventional sintered metal, thereby minimizing its longitudinal shrinkage, without any damage in debinding and sintering processes.

In this case, the term “basic metallic frame product” represents a final product of the present invention before it is machined to turn into a metallic frame. In detail, the basic metallic frame product is a product obtained by separating the metal injection molded product made through a sintering process in a state of being fixed to a support means from the support means and removing fixing means for the metal injection molded product out of the metal injection molded product.

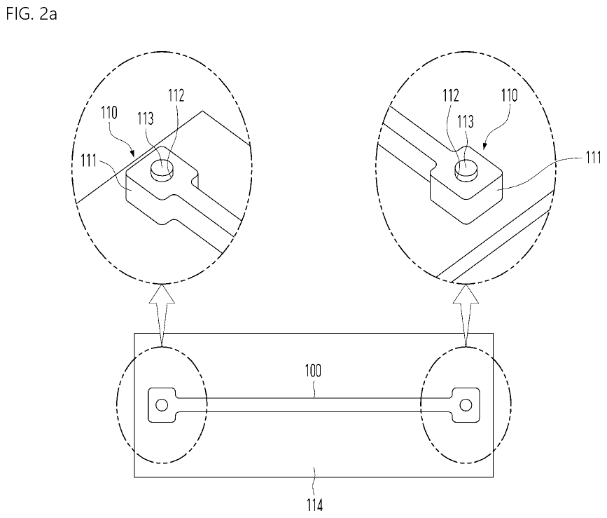

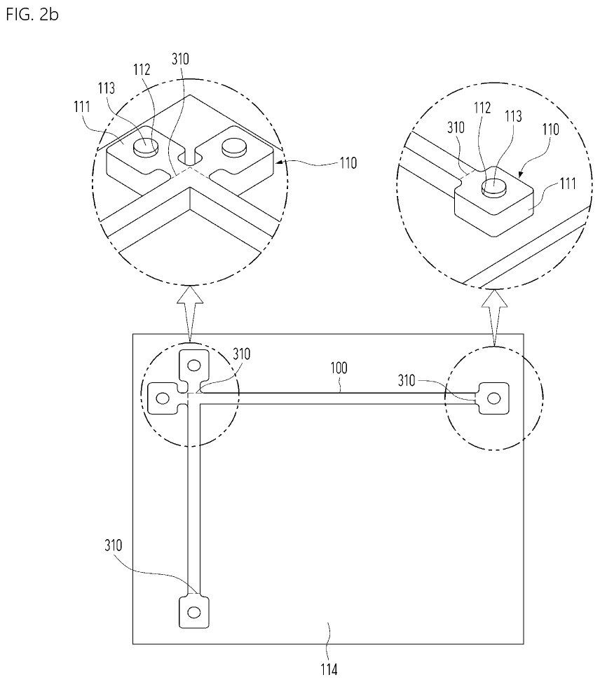

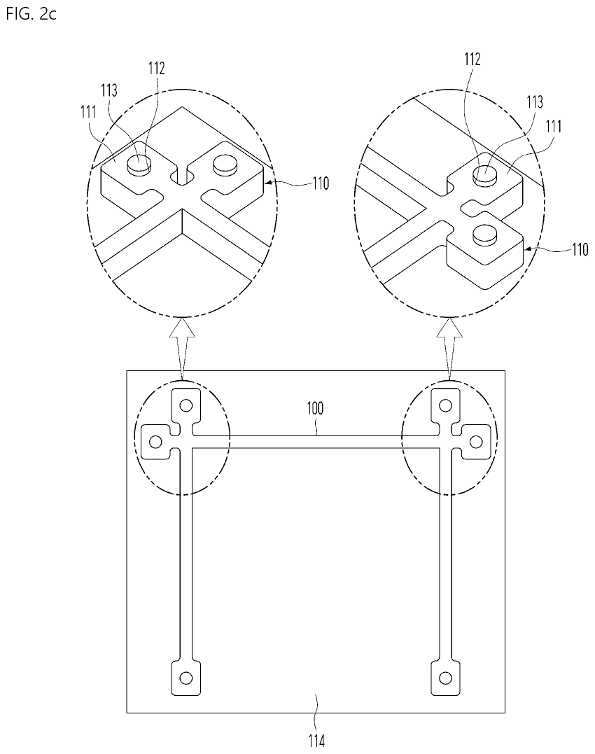

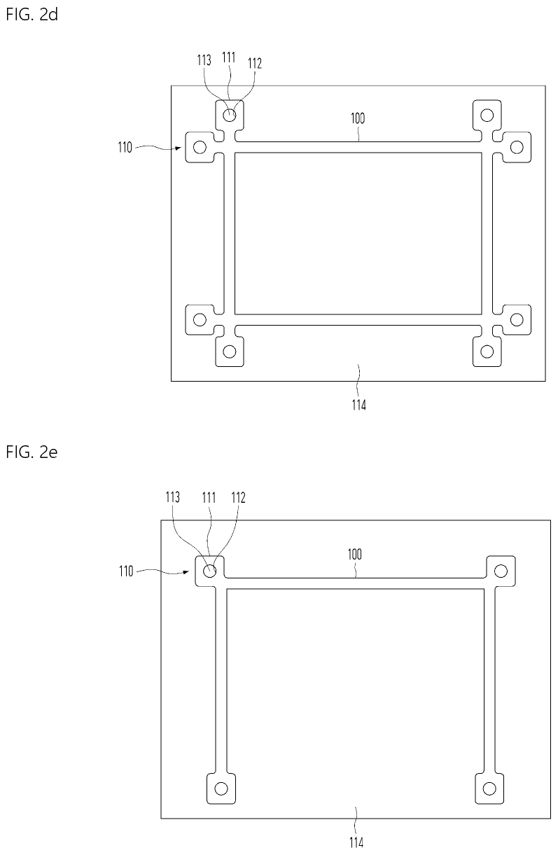

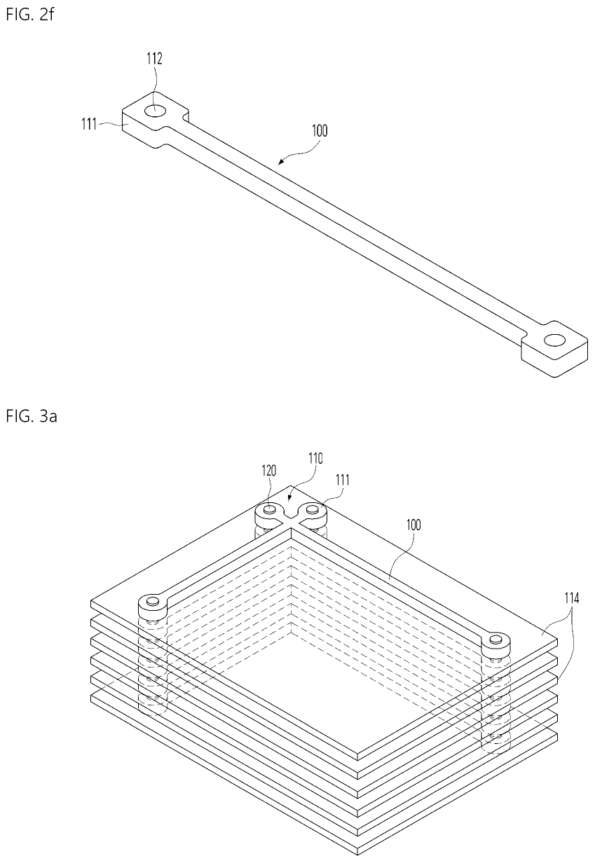

FIGS. 2a to 2d show examples of a metal injection molded system having the metal injection molded product for a metallic frame and the support means, wherein representative four types of systems and support means are shown, while having the metal injection molded product having one side fixing base 111 and the opposite side fixing base 111, fixing pins 113 disposed on the fixing bases 111 in such a way as to be treated on the surfaces coming into contact with the fixing bases to have no reaction to the fixing bases 111, and the support means 114 for fixedly supporting the fixing pins 113.

That is, FIGS. 2a to 2d show examples where the metal injection molded products and the metal injection molded systems having the metal injection molded products are used to make the basic metallic frame products as shown in FIGS. 1a to 1d.

As shown in FIGS. 2a to 2e, each metal injection molded system according to the present invention includes: the metal injection molded product having one or more molded side walls 100 among four side walls for making the basic metallic frame product and fixing means 110 extending from both ends of each molded side wall in the longitudinal direction of the molded side wall to fix the molded side wall in such a way as to prevent the molded side wall from shrinking in the longitudinal direction thereof during the sintering process; and the support means 114 fastened to the fixing means 110 to allow the molded side walls 100 to be resistant to shrinking forces thereof in the longitudinal directions during the sintering process.

The fixing means 110 include the fixing bases 111 extending from both ends of each molded side wall in the longitudinal direction of the molded side wall and fixing portions 112 formed in the fixing bases 111, and the support means 114 includes the fixing pins 113 fastened to the fixing portions 112.

That is, the metal injection molded product has one side fixing base and the opposite side fixing base connected to the outsides of any one or more facing longitudinal ends of the longitudinal direction longer than the width of the molded side wall. The fixing bases are coupled to the fixing pins to hold the molded side wall during the sintering of the metal injection molded product so that the molded side wall does not shrink in the longitudinal direction thereof.

That is, the fixing pins are fastened to the fixing portions of the fixing bases to allow the molded side wall of the metal injection molded product to be fixed to the support means so that during sintering, the molded side wall of the metal injection molded product is kept in shape, thereby producing the basic metallic frame product having a desired dimension and shape.

Referring specifically to FIGS. 2b to 2d, the plurality of side walls 100 are provided to be intersected vertically with one another, and the fixing bases 111 are formed on both ends of each side wall 100.

As shown in FIG. 2b, the metal injection molded product further includes cutting lines 310 formed between the molded side walls 100 and the fixing means 110, and after the metal injection molded product has been sintered, the fixing means 110 are removed from the molded side walls 100 through the cutting lines 310, thereby making the shape of the basic metallic frame product.

FIG. 2e shows an embodiment wherein the metal injection molded product has the shape of [symbol] with the two or more side walls and one fixing base 111 is unitarily formed on the outside of the intersecting portion of the two side walls to prevent the two side walls from shrinking in the longitudinal directions thereof during the sintering.

The fixing means may have various shapes capable of keeping the side wall in shape so that the side wall is prevented from shrinking in the longitudinal direction thereof during the sintering.

FIG. 2f is a perspective view showing the metal injection molded product having one side wall 100 and the fixing bases 111 and the fixing portions 112 formed on both ends of the side wall 100.

Hereinafter, an explanation of a mixture of metal powder and a binder required to manufacture the metal injection molded product will be given.

The metal injection molded product according to the present invention is made through metal injection molding using a mixture of metal powder and a binder.

That is, the metal powder is injection molded to an appropriate shape, and the metal powder is subjected to ceramic sintering, metal sintering, or combined sintering thereof.

To make the metal injection molded product, the binder (bonding agent) as well as the metal powder is used to apply the fluidity to the metal powder and to keep the shape of the metal powder, and the binder has wax and various polymers as main components. If the binder is used, of course, a process of removing the binder has to be additionally performed.

The injection molding mixture in which the metal powder and the binder are mixed is injection molded through a general plastic precision injection molding machine, and accordingly, metal injection molded products having various shapes may be made using the injection molding machine.

The metal powder used for the metal injection molded product according to the present invention comprises one selected from molybdenum, tungsten, and an alloy thereof; alloy steel with Fe as a main component; stainless alloy steel such as SUS630, SUS316, and SUS304; and titanium and titanium alloys or a combination of two or more thereof, and desirably, the metal powder is titanium hydride or stainless alloy steel.

The wax as the binder includes paraffin wax, carnauba wax, and a mixture thereof, and further, various types of wax are used.

The polymers as the binder include polypropylene, polyethylene, polyacetal, amorphous polyalphaolefin, and a combination of two or more thereof, and they may not be limited thereto.

One exemplary process of manufacturing the metal injection molded product is as follows.

### 1) Kneading

The kneading step is a process of mixing metal powder and a binder. A kneading machine is pre-heated to a temperature between 100 and 250° C., and pre-weighed metal powder and binder are poured into the kneading machine to make a mixture thereof. For example, the metal powder and the binder are poured and mixed in the kneading machine set to a temperature between 100 and 250° C., desirably to a temperature between 140 and 170° C., and in this case, the binder is melted to permeate the metal powder because of high temperature so that the binder and the metal powder are kneaded. This process is performed for about one to three hours to allow the binder to be uniformly mixed with the metal powder, so that the mixture of the metal powder and the binder is made.

### 2) Injection

The injection step is a process of pouring the mixture of the metal powder and the binder into an injection molding machine, moving the mixture to a mold through a nozzle, and making the shape of the metal injection molded product. The injection molding machine pushes the mixture of the metal powder and binder poured into a hopper through a screw and moves the mixture to the mold.

In this case, desirably, a speed of the screw is in the range of 20 to 50 m/s, and a temperature of the nozzle is in the range of 120 to 150° C. The mixture discharged from the nozzle moves to the mold and is shaped as the product in the mold. When the mixture is subjected to injection molding, desirably, a holding pressure in the range between 800 and 1000 kgf is applied and a temperature of the mold is set to the range between 30 and 50° C.

3) Supercritical Debinding

The supercritical debinding step is a process where carbon dioxide has a supercritical phase in which a diffusion speed is high and surface tension is low to remove wax from the metal injection molded product. The carbon dioxide having the supercritical phase quickly permeates the ultrafine pores of the metal injection molded product, removes the wax from the metal injection molded product, and is quickly discharged therefrom, thereby enabling effective debinding. Desirably, the supercritical debinding step is performed at a pressure of 200 to 250 bar and a temperature of 70 to 80° C. for 5 to 10 hours.

### 4) Thermal Debinding

The thermal debinding step is a process of applying heat to the metal injection molded product whose debinding is completed to remove the polymers as one of the components of the binder. The polymers remaining after the wax has been removed in the supercritical debinding step are subjected to heat treatment at a temperature greater than 300° C. and thus completely removed. Desirably, the thermal debinding step is kept under argon atmosphere at a temperature of 300° C. for 30 minutes and then kept at a temperature of 450° C. for 30 minutes.

### 5) Sintering

The sintering step is a process where the debinded metal injection molded product is subjected to sintering at a sintering furnace set to a temperature between 900 and 1600° C. to make a basic metallic frame product. At the temperature in the above-mentioned range, metal powder sintering is easily performed, and a sintered material has excellent mechanical strength and surface properties. If the sintering temperature is less than 900° C., the surface properties and mechanical properties of the sintered material are deteriorated, and if the sintering temperature is greater than 1600° C., the mechanical properties of the sintered material are deteriorated. The sintering process is performed under gas atmosphere where any one of hydrogen and argon or both of them are contained or under vacuum. When the sintering process is performed under gas atmosphere or vacuum, oxidization occurring when oxygen is introduced can be prevented.

One of detailed embodiments where the metal injection molded product according to the present invention is made is as follows.

One of stainless steel, SUS316 is used as the metal powder and mixed with the binder at volume ratios as listed in Table 1 to make the mixtures of the metal powder and the binder.

A composition ratio between the wax and the polymers constituting the binder is represented by % by weight, and a composition ratio between the metal powder and the binder constituting the mixture is represented by % by volume.

Metal powder having particle sizes of 2 to 20 μm is used as the metal powder for making the SUS metal injection molded product. Various types of wax and various types of polymers are used as the binder. Desirably, paraffin wax, carnauba wax, and a mixture thereof that have a melting point of 55 to 75° C. and a density of 0.85 to 0.92 may be used as the wax, and polyacetal (POM) having a melting point of 140 to 170° C. and a density of 1.05 to 1.20, polypropylene (PP) having a melting point of 130 to 165° C. and a density of 0.85 to 0.97, polyethylene (PE) having a melting point of 95 to 135° C. and a density of 0.91 to 0.97, amorphous polyalphaolefin (APAO) having a melting point of 90 to 100° C. and a density of 0.85 to 0.92, and a combination of two or more thereof may be used as the polymers.

The binder desirably comprises 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin, more desirably comprises 45 to 50% by weight of paraffin wax, 1 to 5% by weight of carnauba wax, 10 to 15% by weight of polypropylene, 25 to 30% by weight of polyacetal, and 1 to 5% by weight of amorphous polyalphaolefin.

The amorphous polyalphaolefin used as the polymers serves to improve the binding force of the mixture of the metal powder and the binder so that the metal injection molded product becomes stabilized in shape, thereby obtaining a good quality of basic metallic frame product when sintered.

The mixtures of the metal powder and the binder having the composition ratios as suggested in Table 1 are injected to molds to make the metal injection molded product having the molded side walls and the fixing means as shown in FIG. 2d. The metal injection molded product has a horizontal length of 156 mm, a vertical length of 74 mm, and a thickness of 9 mm, and a width of each molded side wall has 7 mm.

Injection molding possibilities depending upon the composition ratios between the wax and the polymers of the binder and the composition ratios between the binder and the metal powder are suggested in ‘injection molding performance evaluation’ of Table 1.

A reference symbol ‘○’ represented on the injection molding performance evaluation means that the mixture of the metal powder and the binder is stably molded to the shape of the metal injection molded product, a reference symbol ‘Δ’ means that the mixture of the metal powder and the binder is kept to the shape of the metal injection molded product, but it has internal defects, and a reference symbol ‘X’ means that the mixture of the metal powder and the binder is not molded in the mold to the shape of the metal injection molded product.

As appreciated from Table 1, the mixtures of the metal powder and the binder comprising 27.5 to 57.5% by volume of the binder having 40 to 60% by weight of wax and 60 to 40% by weight of polymers and 72.5 to 42.5% by volume of the metal powder have good injection molding performance.

If the metal powder is greater than the above-mentioned percentage by volume, the mixture of the metal powder and the binder does not flow well to cause the injecting molding machine to be easily clogged, and further, the mixture may be easily attached to the mold. If the content of the metal powder is low, fluidity becomes high to fail to perform the molding, and further, the mold may be easily contaminated.

The metal injection molded product, which is stably molded, is subjected to supercritical debinding and thermal debinding, and next, it is fixed to the support means, as shown in FIG. 2d and subjected to sintering, thereby making a basic metallic frame product.

According to the present invention, further, the sintering is performed under the conditions where the sintering furnace is heated up to about 1300° C. and the heating is controlled to a heating rate of 0.5° C. or under lower than a heating rate of 1 to 5° C. per minute typically used. Through such an appropriate heating rate per minute, accordingly, the sintering is performed in a state where the fixing bases formed on both longitudinal ends of the molded side wall are restrained by the fixing pins to suppress the longitudinal deformation of the molded side wall so that deformation occurs in directions excepting the longitudinal direction of the molded side wall to prevent the molded side wall from being broken.

The metal injection molded products made of the mixtures of the metal powder and the binder may be easily deformed due to shrinkage when sintered, and further, defects such as twists, cuts, and the like that are caused by the deformation may be made. The states of the basic metallic frame products made by sintering the metal injection molded products are represented as ‘sintered states’ of Table 1.

A reference symbol ‘⊚’ represented on the ‘sintered states’ means that the metal injection molded product is very stably sintered to the shape of the basic metallic frame product, a reference symbol ‘○’ means that the metal injection molded product is stably sintered to the shape of the basic metallic frame product, a reference symbol ‘Δ’ means that the metal injection molded product is sintered to be somewhat deformed, and a reference symbol ‘X’ means that the metal injection molded product is sintered to be seriously deformed and thus does not have the shape of the basic metallic frame product.

As appreciated from Table 1, the metal injection molded products made of the mixtures of the metal powder and the binder comprising 35 to 52.5% by volume of the binder having 40 to 60% by weight of wax and 60 to 40% by weight of polymers and 65 to 47.5% by volume of the metal powder are sintered to good basic metallic frame products, more particularly the metal injection molded products made of the mixtures of the metal powder and the binder comprising 40 to 45% by volume of the binder having 40 to 60% by weight of wax and 60 to 40% by weight of polymers and 60 to 55% by volume of the metal powder are sintered to very good basic metallic frame products.

In the case where the binder desirably comprises 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin, injection molding performance and sintered states are good, and in this case, the binder more desirably comprises 45 to 50% by weight of paraffin wax, 1 to 5% by weight of carnauba wax, 10 to 15% by weight of polypropylene, 25 to 30% by weight of polyacetal, and 1 to 5% by weight of amorphous polyalphaolefin.

According to the above-mentioned embodiments, the basic metallic frame product having the shape as shown in FIG. 2d is made, but without being limited thereto, the embodiments may be applied to make metallic frame basis products having various shapes and thicknesses.

The metal injection molded products after sintered are separated from the fixing pins of the support means, and the fixing bases are cut and removed to obtain the basic metallic frame products as shown in FIGS. 1a to 1d.

TABLE 1
Embodiments of metal injection molded products
using mixtures of metal powder and binder

| | Mixtures for metal injection molding | | | | | |
|---|---|---|---|---|---|---|
| | (% by volume) | | | | | |
| | | Binder | | | | |
| | | | Composition ratio | | Injection | |
| | | | (% by weight) | | molding | Sintered |
| Nos. | SUS316 | | Wax | Polymers | performance | states |
| Embodiment 1 | 40 | 60 | 30 | 70 | X | |
| Embodiment 2 | 42.5 | 57.5 | 40 | 60 | ◯ | X |
| Embodiment 3 | 45 | 55 | 50 | 50 | ◯ | X |
| Embodiment 4 | 47.5 | 52.5 | 60 | 40 | ◯ | ◯ |
| Embodiment 5 | 50 | 50 | 70 | 30 | X | |
| Embodiment 6 | 52.5 | 47.5 | 30 | 70 | X | |
| Embodiment 7 | 55 | 45 | 40 | 60 | ◯ | ⊚ |
| Embodiment 8 | 57.5 | 42.5 | 50 | 50 | ◯ | ⊚ |
| Embodiment 9 | 60 | 40 | 60 | 40 | ◯ | ⊚ |
| Embodiment | 62.5 | 37.5 | 70 | 30 | X | |
| 10 | | | | | | |
| Embodiment | 65 | 35 | 30 | 70 | X | |
| 11 | | | | | | |
| Embodiment | 67.5 | 32.5 | 40 | 60 | ◯ | Δ |
| 12 | | | | | | |
| Embodiment | 70 | 30 | 50 | 50 | ◯ | X |
| 13 | | | | | | |
| Embodiment | 72.5 | 27.5 | 60 | 40 | ◯ | X |
| 14 | | | | | | |
| Embodiment | 75 | 25 | 70 | 30 | X | |
| 15 | | | | | | |
| Embodiment | 65 | 35 | 60 | 40 | ◯ | ◯ |
| 16 | | | | | | |
| Embodiment | 65 | 35 | 40 | 60 | ◯ | ◯ |
| 17 | | | | | | |

Another detailed embodiment where the metal injection molded product according to the present invention is made is as follows.

Titanium hydride having particle sizes of 5 to 30 μm is used as metal powder and kneaded with a binder at the volume ratios as listed in Table 2, thereby making mixtures of the metal powder and the binder.

Titanium is a non-magnetic material having low thermal expansion coefficient and excellent oxidation resistance and has better strength and lower specific gravity than other metals such as SUS alloy steel, carbon steel, and the like, thereby advantageously making a lightweight basic metallic frame product. Contrarily, titanium has a high melting point and difficulty machinability, and accordingly, it is hard to mass-produce the metallic frames made of titanium.

Further, in the case of titanium hydride to which the metal injection molding is applied, the metal injection molded product may greatly shrink by the dehydrogenation reaction of titanium hydride when sintered, so that it is more difficult that the metallic frame is made using the metal injection molded product with the titanium hydride than with the stainless steel alloy.

A process of making the basic metallic frame product using titanium hydride is the same as of making the basic metallic frame product using the SUS metal powder unless no specific description is suggested.

In the case where titanium hydride is used as the metal powder, a desirable composition of the binder is as follows.

The binder desirably comprises 40 to 60% by weight of paraffin wax having a melting point of 55 to 75° C. and a density of 0.85 to 0.92, 15 to 30% by weight of polypropylene having a melting point of 130 to 165° C. and a density of 0.85 to 0.97, 10 to 30% by weight of polyethylene having a melting point of 95 to 135° C. and a density of 0.91 to 0.97, and 1 to 10% by weight of amorphous polyalphaolefin having a melting point of 90 to 100° C. and a density of 0.85 to 0.92, more desirably comprises 55 to 60% by weight of paraffin wax, 15 to 20% by weight of polypropylene, 15 to 20% by weight of polyethylene, and 1 to 5% by weight of amorphous polyalphaolefin.

Injection molding possibilities depending upon the composition ratios between the wax and the polymers of the binder and the composition ratios between the binder and the metal powder are suggested in ‘injection molding performance evaluation’ of Table 2.

As appreciated from Table 2, the mixtures of metal powder and binder comprising 25 to 55% by volume of the binder having 40 to 60% by weight of wax and 60 to 40% by weight of polymers and 75 to 45% by volume of the metal powder have good injection molding performance.

The metal injection molded products, which are stably molded, are subjected to supercritical debinding and thermal debinding.

In the case where titanium hydride is used as the metal powder, the debinding process is performed under hydrogen atmosphere. Even though no specific description is suggested in Table 2, when even the metal injection molded products stably molded are subjected to the debinding process under non-hydrogen atmosphere, the sintered states of the basic metallic frame products may be defective. This is because hydrogen is lost even the debinding process so that even the metal injection molded products stably molded may be deformed in shape after sintered.

The metal injection molded products after the debinding are fixed to the support means, as shown in FIG. 2d and then subjected to sintering, thereby making basic metallic frame products.

According to the present invention, further, in the case of using titanium hydride for the metal powder, hydrogen is lost, when sintered, so that the metal injection molded product using titanium hydride powder may shrink to a larger extent than the metal injection molded product using the stainless steel alloy powder. Accordingly, if the fixing means and the support means are disposed to come into close contact with each other (that is, if a restrained gap therebetween is 0%), the molded side wall may be twisted or cracked during the sintering process. At the time when the debinded metal injection molded product is fixed to the support means, therefore, there is a need to keep a given distance between the fixing means and the support means.

The given distance between the fixing means and the support means is represented as a restrained gap, and the restrained gap is defined as the half of the value obtained by dividing a distance between the fixing portion of the fixing means and the fixing pin of the support means by a molded product length in a direction of the distance between the fixing portion and the fixing pin and then multiplying 100 by the divided value.

TABLE 2
Embodiments of metal injection molded products using
mixtures of titanium hydride powder and binder

| | Mixtures for metal injection | | | | | | |
|---|---|---|---|---|---|---|---|
| | molding (% by volume) | | | | | | |
| | | Binder | | | | | |
| | | | Composition | | | | |
| | | | ratio (% by | | Injection | | |
| | Titanium | | weight) | | molding | Restrained | Sintered |
| Nos. | hydride | | Wax | Polymers | performance | gaps | states |
| Embodiment | 30 | 70 | 30 | 70 | X | | |
| 18 | | | | | | | |
| Embodiment | 35 | 65 | 40 | 60 | ◯ | 0.5% | X |
| 19 | | | | | | | |
| Embodiment | 40 | 60 | 50 | 50 | ◯ | 1% | X |
| 20 | | | | | | | |
| Embodiment | 45 | 55 | 60 | 40 | ◯ | 1.5% | ◯ |
| 21 | | | | | | | |
| Embodiment | 50 | 50 | 70 | 30 | X | | |
| 22 | | | | | | | |
| Embodiment | 50 | 50 | 30 | 70 | X | | |
| 23 | | | | | | | |
| Embodiment | 55 | 45 | 40 | 60 | ◯ | 3% | ◯ |
| 24 | | | | | | | |
| Embodiment | 55 | 45 | 50 | 50 | ◯ | 3.5% | ◯ |
| 25 | | | | | | | |
| Embodiment | 60 | 40 | 60 | 40 | ◯ | 4% | ◯ |
| 26 | | | | | | | |
| Embodiment | 60 | 40 | 70 | 30 | X | | |
| 27 | | | | | | | |
| Embodiment | 65 | 35 | 30 | 70 | Δ | 5% | Δ |
| 28 | | | | | | | |
| Embodiment | 70 | 30 | 40 | 60 | ◯ | 4% | ◯ |
| 29 | | | | | | | |
| Embodiment | 70 | 30 | 40 | 60 | ◯ | 5.5% | Δ |
| 30 | | | | | | | |
| Embodiment | 75 | 25 | 50 | 50 | ◯ | 6% | Δ |
| 31 | | | | | | | |
| Embodiment | 30 | 70 | 60 | 40 | ◯ | 0% | X |
| 32 | | | | | | | |
| Embodiment | 35 | 65 | 70 | 30 | X | | |
| 33 | | | | | | | |
| Embodiment | 40 | 60 | 30 | 70 | X | | |
| 34 | | | | | | | |
| Embodiment | 45 | 55 | 40 | 60 | ◯ | 1.5% | ◯ |
| 35 | | | | | | | |
| Embodiment | 50 | 50 | 50 | 50 | ◯ | 2% | ◯ |
| 36 | | | | | | | |
| Embodiment | 50 | 50 | 60 | 40 | ◯ | 2.5% | ◯ |
| 37 | | | | | | | |
| Embodiment | 55 | 45 | 70 | 30 | X | | |
| 38 | | | | | | | |
| Embodiment | 55 | 45 | 30 | 70 | X | | |
| 39 | | | | | | | |
| Embodiment | 60 | 40 | 40 | 60 | ◯ | 4% | ◯ |
| 40 | | | | | | | |
| Embodiment | 60 | 40 | 50 | 50 | ◯ | 4.5% | ◯ |
| 41 | | | | | | | |
| Embodiment | 65 | 35 | 60 | 40 | ◯ | 5% | Δ |
| 42 | | | | | | | |
| Embodiment | 70 | 30 | 70 | 30 | Δ | 5.5% | Δ |
| 43 | | | | | | | |
| Embodiment | 75 | 25 | 30 | 70 | Δ | 6% | Δ |
| 44 | | | | | | | |

As appreciated from Table 2, in the case where the metal injection molded products comprising 25 to 55% by volume of the binder having 40 to 60% by weight of wax and 60 to 40% by weight of polymers and 75 to 45% by volume of the metal powder are fixed to the support means in such a way as to have the restrained gaps in the range of 1.5 to 5.5%, desired basic metallic frame products are obtained, and especially in the case where the restrained gaps are in the range of 1.5 to 5%, good quality basic metallic frame products are obtained.

Hereinafter, other examples of the fixing bases, the fixing portions, the fixing pins, and the support means according to the present invention will be explained.

The fixing pins fastened to the fixing portions of the fixing bases function as parts of the support means because their other portion is fixed to the support means. The fixing bases and/or the fixing portions and the fixing pins are configured to be easily separated from one another after the sintering process. That is, the fixing pins are treated so that they do not react to the fixing bases and/or the fixing portions. To do this, the fixing pin is entirely made of an unreactive material that does not react to the fixing portion, and otherwise, the outer peripheral surface of the fixing pin is made of an unreactive material that does not react to the fixing portion, while a stiff metal is fitted to the interior of the fixing pin. Otherwise, an unreactive material or solution is applied to any one or more surfaces where the fixing base and/or the fixing portion and the fixing pin are brought in contact with each other when fastened, and next, the unreactive material or solution is dried or sintered. The unreactive material includes any one of ceramic powder and graphite powder or a combination of two or more thereof.

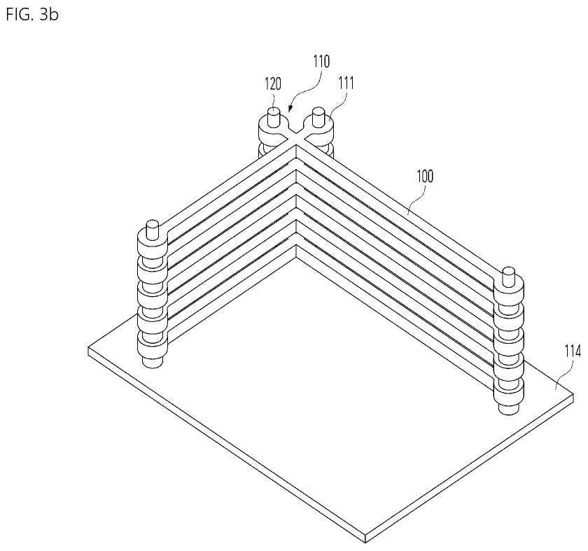

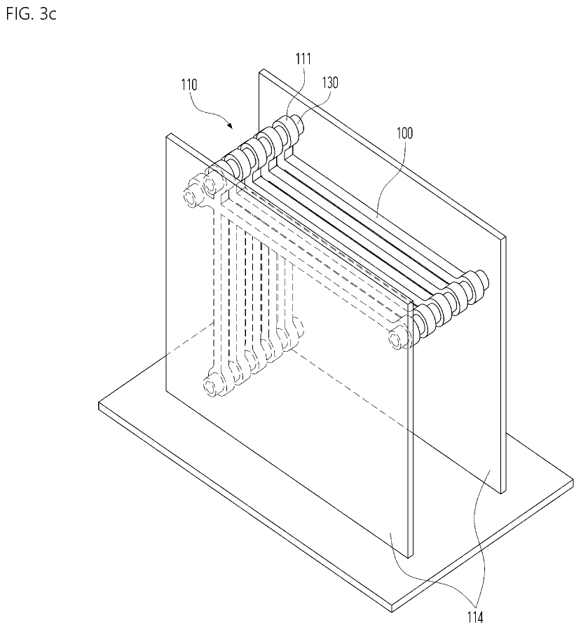

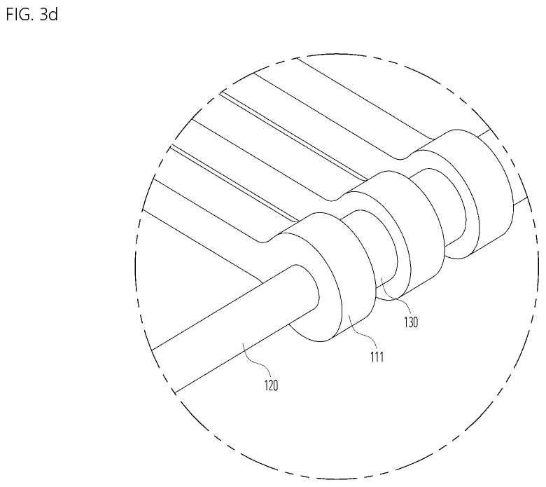

FIGS. 3a to 3c show metal injection molded systems according to other embodiments of the present invention in which two or more metal injection molded products are stacked on top of one another and are sintered at a time.

Referring to FIG. 3a, multi-connection fixing pins 120 passing through the plurality of support means fixingly pierce the fixing portions of the metal injection molded products disposed on the respective support means. That is, the plurality of support means are coupled to one another in a stacked manner in thickness directions of the metal injection molded products, thereby producing a plurality of basic metallic frame products at a time.

In this case, each support means for fixedly supporting the multi-connection fixing pins 120 is located between the neighboring metal injection molded products in such a way as to pass the multi-connection fixing pins therethrough, and the support means is formed of a plate made of any one of ceramic and graphite or a combination of two or more thereof. Otherwise, the support means may be formed of a plate to which powder or solution made of any one of ceramic and graphite or a combination of two or more thereof is applied and then dried or sintered.

FIG. 3b shows the example of a metal injection molded system wherein a plurality of metal injection molded products are stacked on top of one another, while being spaced apart from one another by means of spacing members 130, and multi-connection pins 120 fixed to top of the support means 114 fittedly pass through the fixing portions of the metal injection molded products.

Referring to FIGS. 3b and 3d, the spacing members 130 are disposed between the neighboring fixing bases 111 in height directions, and accordingly, the neighboring fixing bases 111 in thickness directions are kept spaced apart from one another. Desirably, the spacing members 130 are treated to have no react to the metal injection molded products.

Referring to FIG. 3c, a metal injection molded system includes a pair of support means 114 disposed vertically to the ground in such a way as to be spaced apart from each other in parallel to each other and multi-connection fixing pins 120 coupled to the support means 114 in a thickness direction of the support means 114. That is, the fixing portions formed on the fixing bases are disposed vertically to the ground in a stacked manner in such a way as to hang on the multi-connection fixing pins. Further, the spacing members 130 are disposed between the neighboring fixing bases to prevent the fixing bases located between the neighboring metal injection molded products from coming into close contact with each other.

Now, other examples of the fixing means and the support means of the metal injection molded system according to the present invention will be explained.

Each fixing means is formed of a transverse fixing rod extending from the end of the molded side wall in any one or more directions of left and right directions, and otherwise, the fixing means is formed of an end corner having a bent portion formed on one side of the end of the molded side wall.

Further, each support means includes one or more corner inside supports coming into contact with the inside corners formed by the molded side wall and the transverse fixing rod or coming into contact with the inside corner formed by the end corner, and the corner inside supports are coupledly fixed to the support means. Further, the corner inside supports may have various shapes so that they have surface contacts with the side walls of the transverse fixing rods and the end corners.

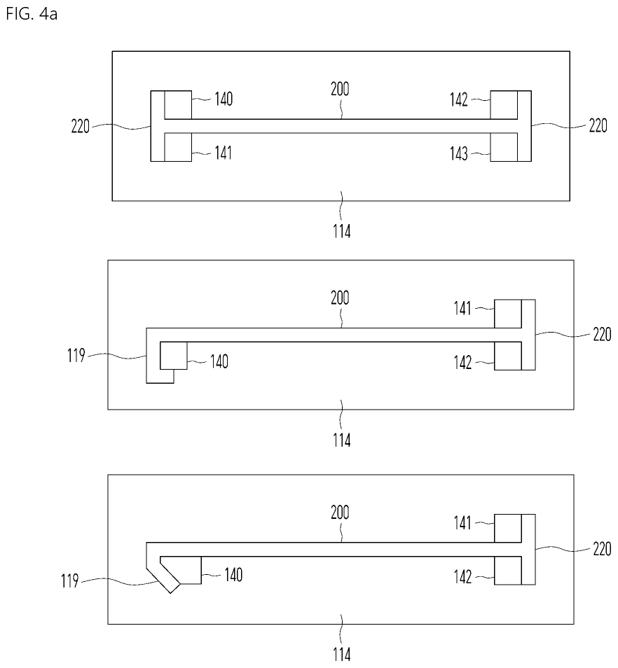

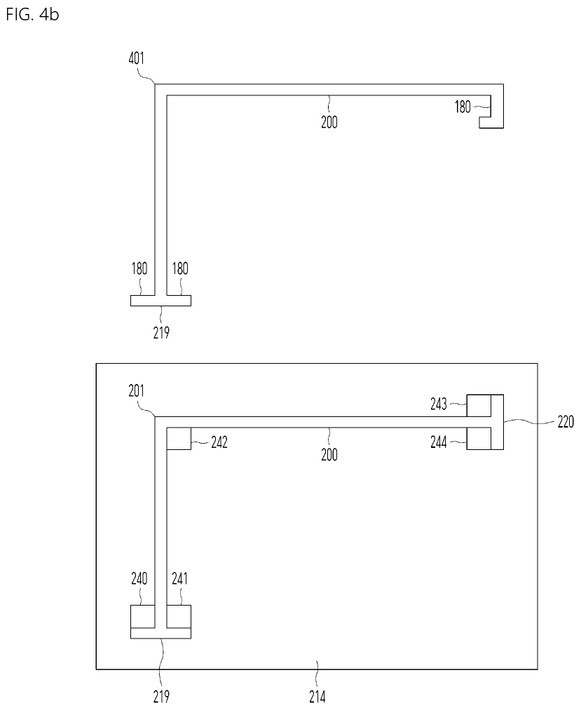

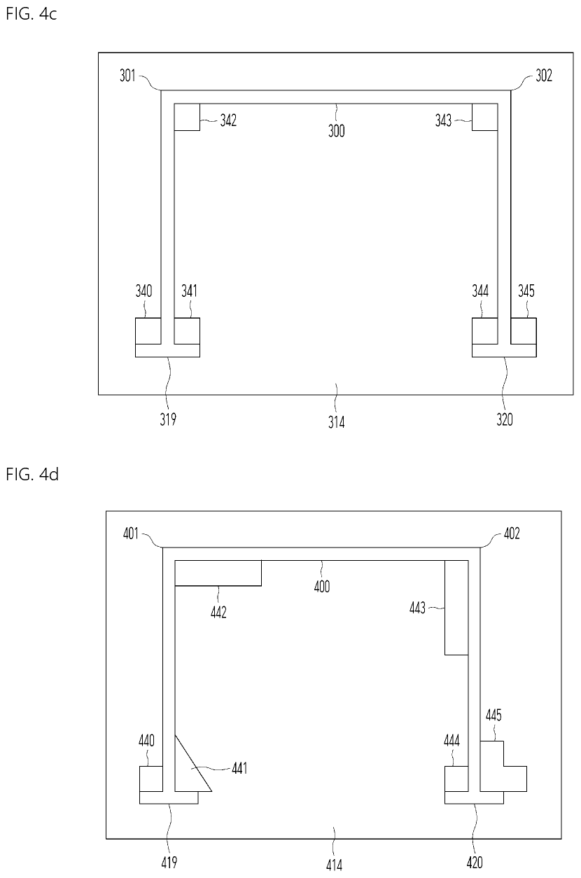

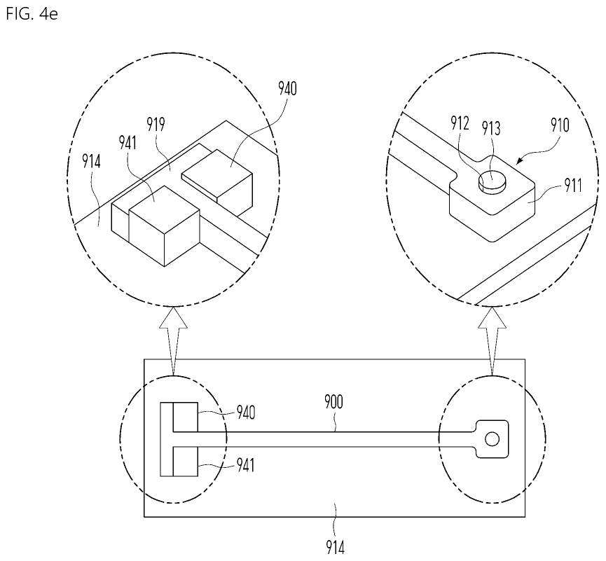

FIG. 4a shows examples of the fixing means and the support means according to the present invention.

FIGS. 4a and 4b show metal injection molded systems wherein the transverse fixing rods 220 or the end corners 119 that extend from the ends of the molded side wall 200 in any one or more directions of the left and right directions are formed as a portion of the molded product and one or more corner inside supports 140, 141, 142, and 143 are provided to come into contact with the inside corners 180 formed by the molded side wall and the transverse fixing rods or the end corners. The corner inside supports are fastendly fixed to the support means 114, and the corner inside supports and the transverse fixing rods and/or the end corners serve to fix both ends of the molded side wall so that the molded side wall does not shrink in the longitudinal direction thereof during the sintering process.

Each corner inside support is made of an unreactive material that does not react to the metal injection molded product during the sintering process, and otherwise, the contact surfaces between the transverse fixing rod or the end corner and the corner inside support are treated so that they do not react to each other. The treatment is the same as mentioned above.

As shown in FIG. 4e, in the case where the fixing means 910 and 919 are disposed on both ends of the side wall 900 of the metal injection molded product, one side fixing means 910 is provided to the form of the fixing base 911 having the fixing portion 912, and the other side fixing means 919 is provided to the form of the transverse fixing rod 919 or the end corner, and according to the types of fixing means, the support means 914 includes the fixing pin 913 or the corner inside supports 940 and 941.

As mentioned above, if the transverse fixing rod or the end corner as the fixing means and the corner inside supports as the support means are provided, the restrained gap between the fixing means and the support means is defined as the half of the value obtained by dividing a distance between the molded side wall and the transverse fixing rod or the corner inside support by a molded product length in a direction of the distance between the molded side wall and the corner inside support and then multiplying 100 by the divided value.

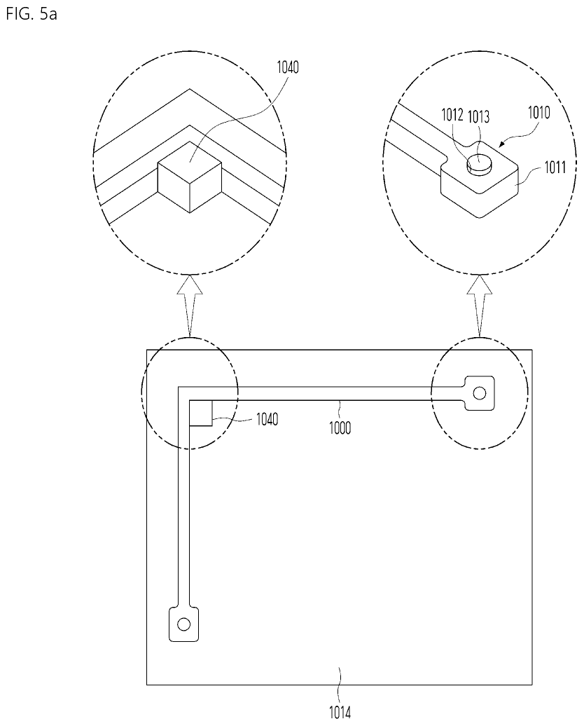

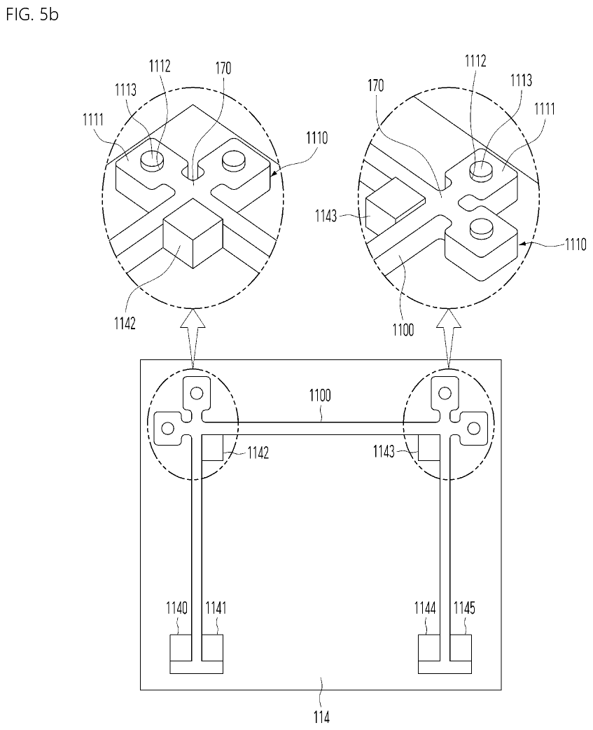

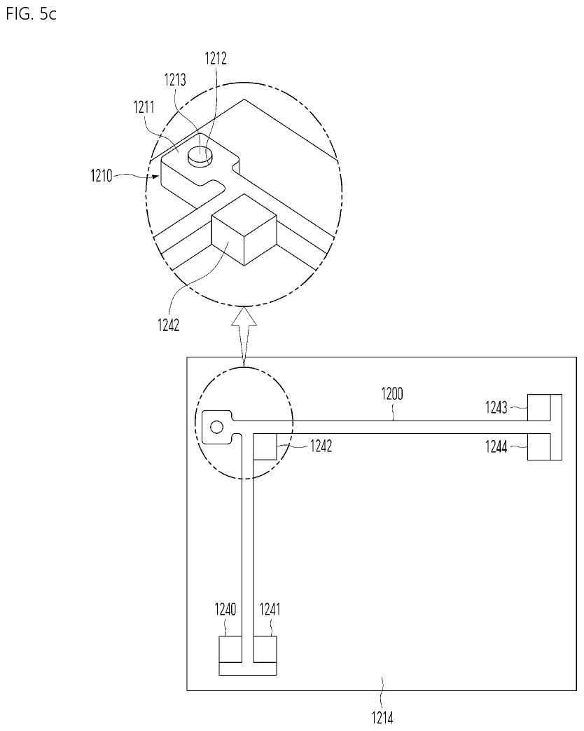

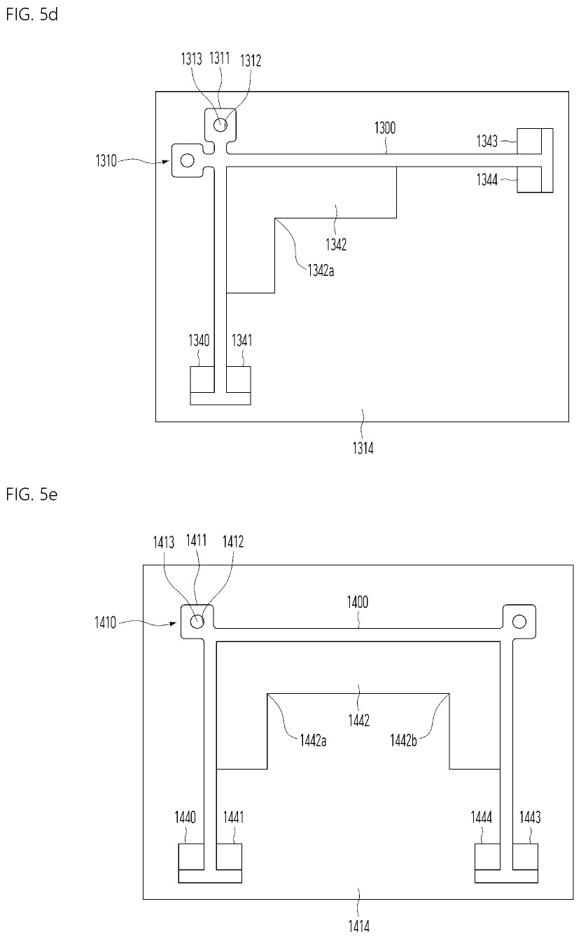

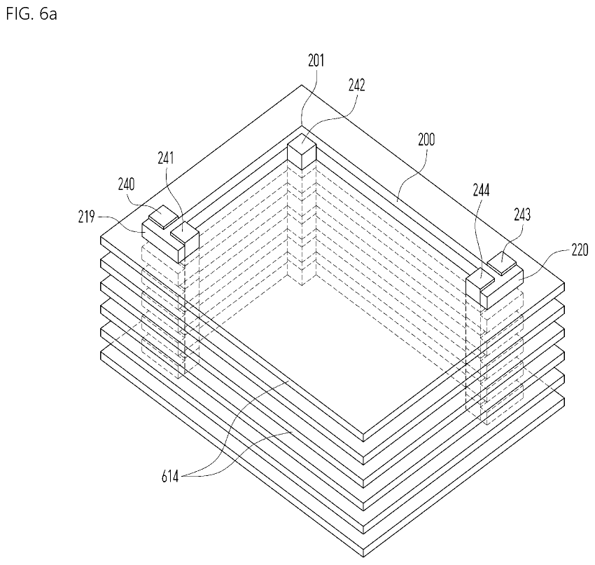

Referring to FIGS. 4b to 4d and FIGS. 5a to 5e, if the metal injection molded product has the shape of ‘ [symbol] ’ having two molded side walls or the shape of ‘ [symbol] =’ having three molded side walls, one or more inside fixing supports 242, 342, 343, 442, 443, 1040, 1142, 1143, 1242, 1342, and 1442 are additionally disposed along the inner surfaces of intermediate bending portions 201, 301, 302, 401, and 402 where the side walls intersect or along the inner surfaces of side wall intermediate corners 170 where the fixing means intersect, and the inside fixing supports are fixedly fastened to the support means. The inside fixing supports as well as the fixing means serve to prevent the side walls from shrinking in the longitudinal directions thereof during the sintering process.

The inside fixing supports may have various sizes and shapes according to the shapes and sizes of the metal injection molded product, and to prevent them from reacting to the metal injection molded product during the sintering process, further, they may contain an unreactive material or be treated to have no reaction to the metal injection molded product, in the same manner as the corner inside supports.

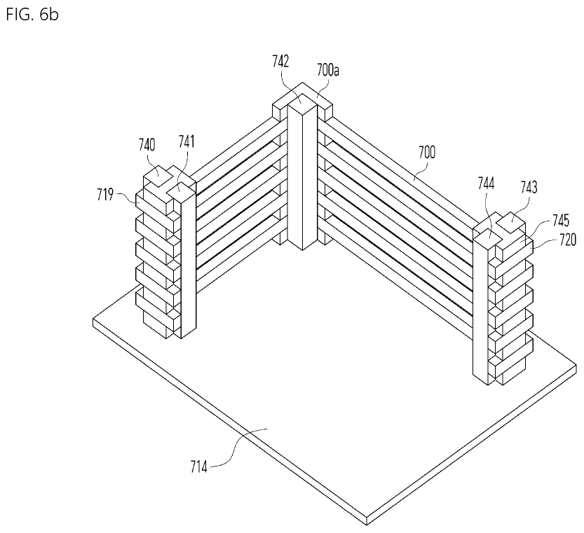

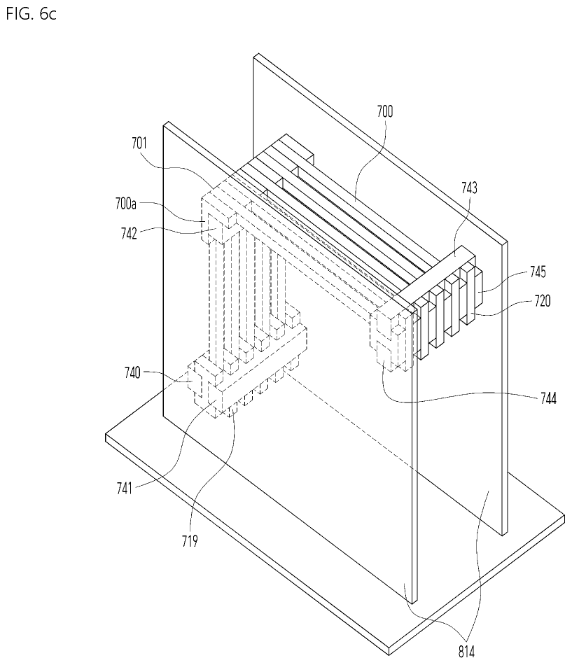

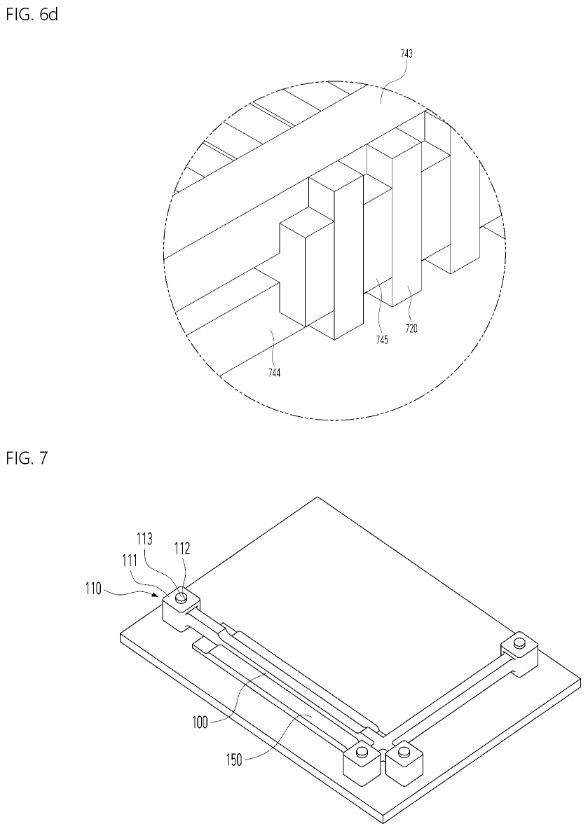

FIGS. 6a to 6c show metal injection molded systems according to other embodiments of the present invention, wherein in the case of the metal injection molded product having the transverse fixing rods as the fixing means, the two or more metal injection molded products are stacked on top of one another at a time.

FIG. 6a shows a metal injection molded system where a plate-shaped support means 614 is located between the neighboring metal injection molded products and multi-connection corner inside supports 240, 242, 243, and 244 and multi-connection inside fixing supports 242 are disposed to pass through the support means 614. The multi-connection corner inside supports and the multi-connection inside fixing supports are coupled to the transverse fixing rods 219 and 220 and the intermediate bending portions 210 of the plurality of metal injection molded products. The support means is located between the neighboring metal injection molded products and made of any one of ceramic powder and graphite powder or a combination of two or more thereof.

FIG. 6b shows a metal injection molded system where transverse fixing rods 719 and 720 and the intermediate bending portions of the plurality of metal injection molded products stacked on top of one another are fixed to multi-connection corner inside supports 740, 741, 743, and 744 and multi-connection inside fixing supports 742, and spacing members 700a and 745 are inserted into the spaces between the neighboring metal injection molded products so that the metal injection molded products are sintered in a state of being separated from one another. The spacing members may have various shapes and be formed of plates located between the neighboring metal injection molded products to supportingly separate the metal injection molded products from the multi-connection corner inside supports. Each plate is made of any one of ceramic powder and graphite powder or a combination of two or more thereof.

FIG. 6c shows a metal injection molded system where a plurality of metal injection molded products are stacked on top of one another and a pair of support means 814 is disposed vertical to the ground in such a way as to be spaced apart from each other in parallel to each other, so that the plurality of metal injection molded products are supported against the multi-connection corner inside supports 740, 741, and 744 and the multi-connection inside fixing supports 742 fixed to the insides of the support means in a state of being separated from one another by means of the spacing members 700a and 745.

FIGS. 6a to 6c are just exemplary embodiments, and therefore, they may have other various embodiments.

FIG. 6d shows an enlarged view of a portion of FIG. 6c.

The present invention may further include various means for supporting the side wall of the metal injection molded product, and such an embodiment is suggested in FIG. 7. As shown, a metal injection molded system according to the present invention further includes a guide member 150 adapted to make the thickness, width, etc. of the molded side wall differently formed in shape, and the guide member 150 as shown in FIG. 7 supports the thickness direction of the molded side wall 100 to allow a portion where the molded side wall is low in thickness to be formed when sintered. Through the guide member 150, the basic metallic frame products may be differently changed in shape to make the metallic frames having various shapes.

The guide member as shown in FIG. 7 supports the thickness direction of the molded side wall of the metal injection molded product, but of course, the guide member may support the inner surface, the outer surface, the inner and outer surfaces, or the width direction of the molded side wall. If the molded side wall is long to be hard to be supported only through the corner inside supports, further, the guide member is additionally disposed on a portion of the molded side wall to prevent the molded side wall from being deformed when sintered.

The guide member is treated to have no reaction to the metal injection molded product during the sintering process, and the above-mentioned same treatment may be applied to the guide member.

A method for manufacturing a basic metallic frame product according to the present invention is carried out to have the metal injection molded product with one side fixing means connected to the outside of a longitudinal end of at least one or more ends longer in a longitudinal direction than the width thereof and the other side fixing means disposed on the opposite side thereto and the support means treated to have no reaction to the fixing means during the sintering process, so that the changes in the length of the metal injection molded product during the sintering process are minimized to stably make the metallic frame product having excellent dimension precision.

As a result, the number of post-machining processes is remarkably reduced in making the metallic frame product having the desired shape, thereby greatly saving the manufacturing time and cost and enabling mass production.

Although various aspects of the disclosed method for manufacturing a basic metallic frame product have been shown and described, modifications may occur to those skilled in the art upon reading the specification. The present application includes such modifications and is limited only by the scope of the claims.

### INDUSTRIAL APPLICABILITY

The present invention relates to the metal injection molded product used to make the metallic frame inserted into a casing of an electronic product such as a smartphone, a smart key, and the like, the metal injection molded system for making the basic metallic frame product using the metal injection molded product, and the method for manufacturing the basic metallic frame product using the system, thereby being excellent in the industrial applicability thereof.

1. A metal injection molded product comprising:
a molded side wall to be provided as a basic metallic frame product after a sintering process; and
fixing means extending from one or both ends of the molded side wall in a longitudinal direction of the molded side wall to fix the molded side wall thereto, so that the molded side wall is prevented from shrinking in the longitudinal direction thereof during the sintering process, and cutting after the sintering process in such a way as to be removable from the molded side wall.

2. The metal injection molded product according to claim 1, wherein the fixing means comprises any one selected among a fixing base extending from the end of the molded side wall in the longitudinal direction of the molded side wall and having a fixing portion formed therein, a transverse fixing rod extending from the end of the molded side wall in any or more directions of left and right directions of the molded side wall, and an end corner having a bent portion formed on one side of the end of the molded side wall, or a combination thereof.

3. The metal injection molded product according to claim 2, having the shape open in one direction or the shape closed.

4. The metal injection molded product according to claim 3, wherein the fixing means formed on a portion where the molded side walls intersect are unified as one to fix the corresponding molded side walls thereto.

5. The metal injection molded product according to claim 2, wherein the molded side wall is any one among a straight type molded side wall having one side wall, a [symbol] -shaped molded side wall having two side walls, a [symbol] -shaped molded side wall having three side walls, and a square type molded side wall having four side walls.

6. The metal injection molded product according to claim 2, comprising metal powder comprising one selected from molybdenum, tungsten, and an alloy thereof; alloy steel with Fe as a main component; stainless alloy steel such as SUS630, SUS316, and SUS304; and titanium and titanium alloys, or a combination of two or more thereof.

7. The metal injection molded product according to claim 2, comprising a mixture of metal powder and a binder comprising 45 to 75% by volume of the metal powder and 55 to 25% by volume of the binder.

8. The metal injection molded product according to claim 7, wherein the mixture of the metal powder and the binder comprises: 45 to 75% by volume of titanium hydride powder; and 55 to 25% by volume of the binder comprising 40 to 60% by weight of paraffin wax, 15 to 30% by weight of polypropylene, 10 to 30% by weight of polyethylene, and 1 to 10% by weight of amorphous polyalphaolefin.

9. The metal injection molded product according to claim 7, wherein the mixture of the metal powder and the binder comprises: 47.5 to 65% by volume of stainless alloy steel powder; and 52.5 to 35% by volume of the binder comprising 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin.

10. The metal injection molded product according to claim 1, further comprising a cutting line between the molded side wall and the fixing means.

11. A basic metallic frame product made by sintering a metal injection molded product comprising a molded side wall to be provided as the basic metallic frame product after a sintering process and fixing means extending from one or both ends of the molded side wall in a longitudinal direction of the molded side wall to fix the molded side wall thereto, so that the molded side wall is prevented from shrinking in the longitudinal direction thereof during the sintering process, and cutting after the sintering process in such a way as to be removable from the molded side wall.

12. A metal injection molded system comprising: a metal injection molded product comprising a molded side wall to be provided as a basic metallic frame product after a sintering process and fixing means extending from one or both ends of the molded side wall to fix the molded side wall thereto, so that the molded in a longitudinal direction of the molded side wall side wall is prevented from shrinking in the longitudinal direction thereof during the sintering process, and cutting after the sintering process in such a way as to be removable from the molded side wall; and a support means coupled to the fixing means to prevent the molded side wall from shrinking in the longitudinal direction thereof during the sintering process.

13. The metal injection molded system according to claim 12, wherein the fixing means comprises any one selected among a fixing base extending from the end of the molded side wall in the longitudinal direction of the molded side wall and having a fixing portion formed therein, a transverse fixing rod extending from the end of the molded side wall in any or more directions of left and right directions of the molded side wall, and an end corner having a bent portion formed on one side of the end of the molded side wall, or a combination thereof.

14. The metal injection molded system according to claim 13, wherein the support means comprises either one or more fixing pins coupled to the fixing portion or one or more corner inside supports coming into contact with inner corners formed by the transverse fixing rod or the inner corner of the end corner.

15. The metal injection molded system according to claim 14, wherein the support means further comprises one or more inside fixing supports disposed along the inner surfaces of intermediate bending portions where the molded side walls intersect or along the inner surfaces of side wall intermediate corners where the fixing means intersect.

16. The metal injection molded system according to claim 15, wherein the fixing portion and the fixing pin, the transverse fixing rod or the end corner and the corner inside support, and the intermediate bending portion or the inner surface of the intermediate corner and the inside fixing support are treated to have no reaction to each other.

17. The metal injection molded system according to claim 16, wherein the treatment is performed by selecting one among (a) a method in which the fixing pin, the corner inside support, or the inside fixing support is entirely made of an unreactive material that does not react to the fixing portion, the transverse fixing rod, the end corner, or the inner surface of the intermediate bending portion or the intermediate corner, (b) a method in which an unreactive material that does not react to the fixing portion, the transverse fixing rod, the end corner, or the inner surface of the intermediate bending portion or the intermediate corner is applied to the outer surface of the fixing pin, the corner inside support, or the inside fixing support, and (c) a method in which an unreactive material or solution is applied to any one or more surfaces where the fixing pin, the corner inside support, or the inside fixing support is brought into contact with the fixing portion, the transverse fixing rod, the end corner, or the inner surface of the intermediate bending portion or the intermediate corner when the inner surfaces thereof are fastened and then dried or sintered.

18. The metal injection molded system according to claim 17, wherein the unreactive material comprises any one of ceramic powder and graphite powder or a combination of two or more thereof.

19. The metal injection molded system according to claim 14, wherein a plurality of metal injection molded products fixed correspondingly to a plurality of support means are stacked on top of one another, and the fixing pins or the corner inside supports are provided to the forms of multi-connection fixing pins or multi-connection corner inside supports disposed to pass through the corresponding support means in such a way as to coupledly pass through the fixing portions, the transverse fixing rods, or the end corners of the plurality of metal injection molded products.

20. The metal injection molded system according to claim 14, wherein a plurality of metal injection molded products are spaced apart from one another in a stacked manner by means of spacing members, and the fixing pins or the corner inside supports fixed to the support means are provided to the forms of multi-connection fixing pins or multi-connection corner inside supports coupledly passing through the fixing portions, the transverse fixing rods, or the end corners of the plurality of metal injection molded products.

21. The metal injection molded system according to claim 14, wherein two support means stand up to face each other, while a plurality of metal injection molded products are paced apart from one another in a stacked manner by means of spacing members between the two support means, and the fixing pins or the corner inside supports fixed to the two support means are provided to the forms of multi-connection fixing pins or multi-connection corner inside supports coupledly passing through the fixing portions, the transverse fixing rods, or the end corners of the plurality of metal injection molded products.

22. The metal injection molded system according to claim 20, wherein the support means supporting the plurality of metal injection molded products at a time each comprises one or more multi-connection inside fixing supports disposed along the inner surfaces of intermediate bending portions where the molded side walls intersect or along the inner surfaces of side wall intermediate corners where the fixing means intersect.

23. The metal injection molded system according to claim 22, wherein the support means, the spacing members, the multi-connection fixing pins, the multi-connection corner inside supports, or the multi-connection inside fixing supports are made of an unreactive material that does not react to the molded side walls or treated with the unreactive material.

24. The metal injection molded system according to claim 12, further comprising a guide member for supporting any one or more among the inner surface, the outer surface, the inner and outer surfaces, the width direction, and the thickness direction of the molded side wall.

25. The metal injection molded system according to claim 24, wherein the guide member is configured to have no reaction to the molded side wall.

26. The metal injection molded system according to claim 12, wherein a restrained gap between the support means and the metal injection molded product is in the range of 1.5 to 5.5%.

27. A method for manufacturing a basic metallic frame product, comprising the steps of:
designing a shape of a product to be made by metal injection molding;
making a mold based on the designed shape;
mixing metal powder and a binder to make a mixture of the metal powder and the binder;
injecting the mixture into the mold made according to the shape of the product to be made by the metal injection molding to make a metal injection molded product having a molded side wall for making a metallic frame and fixing means extending from one or both ends of the molded side wall in a longitudinal direction of the molded side wall to fix the molded side wall thereto, so that the molded side wall is prevented from shrinking in the longitudinal direction thereof during a sintering process, and cutting after the sintering process in such a way as to be removable from the molded side wall;
allowing the metal injection molded product to be subjected to debinding, fixed to a support means coupled to the fixing means to prevent the molded side wall of the metal injection molded product from shrinking during the sintering process, and subjected to the sintering process;
separating the sintered metal injection molded product from the support means; and
cutting the fixing means.
